(19) United States
(12) Patent Application Publication
(10) Pub. No.: US 2020/0302256 A1
(43) Pub. Date: Sep. 24, 2020

(54) Molded RFID Tag for Process Seals and Method of Making Same

(71) Applicant: Newman Sanitary Gasket Company, Lebanon, OH (US)

(72) Inventor: David W. J. Newman, Lebanon, OH (US)

(21) Appl. No.: 16/824,053

(22) Filed: Mar. 19, 2020

Related U.S. Application Data
(60) Provisional application No. 62/820,688, filed on Mar. 19, 2019.

(51) Int. Cl. G06K 19/07; F16J 15/3296

(52) U.S. Cl. CPC G06K 19/0723; F16J 15/3296

(57) ABSTRACT

The present sealing member has a body 3 and an extension 2 comprised of moldable plastic and/or curable elastomeric polymeric material. One or more radio frequency identification (RFID) transponders 1 is/are incorporated according to the present method into a preform of the extension and then molded, cured and/or cooled to embed the transponder 1 uniquely, permanently, and accessibly.

### RELATED APPLICATION

The present non-provisional application claims the priority of US Provisional Application No. 62/820,688 filed Mar. 19, 2019 and bearing the same title as above.

### BACKGROUND

The present invention relates to the design and manufacture of sanitary gaskets and other process seals and more particularly to the inclusion of a unique identifier, such as an RFID transponder, and the way it is connected to the seal.

RFID tags have been increasingly used for asset tracking in numerous industries as they provide rapid and reliable wireless access to data stored within them. Being able to track data like article identity, lot number, manufacturing details and expiration date with each individual article through an RFID chip is valuable, particularly when these articles are high cost or may pose a high risk to people, organizations, equipment or the processes where they are used. Such RFID tagging is also used when it is difficult to otherwise affix or access such article specific information because material, geometric or other considerations prevent other means being used (e.g. inking, etching). Traditionally affixed RFID tags must have tamper-evident means to ensure that the tag has always been related to a particular article. It is therefore advantageous to incorporate such tags at the moment of manufacture by means that are permanent.

RFID tagging has become particularly valuable to high value fluid processing industries like oil and gas, aerospace and the like. Of increasing interest are the high-purity processing industries like food, dairy, pharmaceutical and biopharmaceutical processing where numerous RFID-related patents have been filed (e.g. US20120217244A1, US20110199187A1) due to ever more stringent requirements and regulations worldwide. When sensitive processes have been investigated and approved by corporate, third party and governmental agencies, ensuring that approved articles continue to be used in these well-defined and validated processes becomes vital for corporate, consumer and patient safety. The need for RFID tagging applies to both complex assemblies and to the smallest articles like O-rings and gaskets used in these processes.

Normally, sealing members like gaskets and O-rings are difficult to track. This is due to their often similar appearance, their materials of construction being difficult to mark, the need to maintain an uncontaminated and smooth process contact area (e.g. unaffected by inks and undisrupted by molding and/or etching uniquely identifiable information) and the fact that most seals surfaces are not visible once they are installed (being encased by other sealing components required to make a seal). This makes a reliable method of incorporating uniquely identifiable information in seals through RFID tagging of particular interest.

In addition, fluid sealing members are required to perform consistently across a wide spectrum of applications (e.g. static and dynamic applications) and process requirements (e.g. diverse chemical exposure, temperatures, pressures, and other process variables). It is therefore advantageous to have RFID transponders isolated from the environment, the process and the other surrounding sealing components (e.g. ferrules and clamps). This keeps the RFID transponder from changing the intended physical interaction between the sealing components to prevent fluid leakage. This isolation also prevents the RFID transponder from coming into contact with the process fluid as the seal body (3) wears over time, begins to degrade and requires replacement.

Also, it is advantageous to the manufacturer to physically locate the RFID transponder in areas of the sealing member where precision placement is not required, and seal geometry is not as restricted. Placement within the body of the sealing member in an area which must interact with the other articles of the seal assembly (e.g. ferrules, clamps and the like) forces the manufacturer to accommodate the geometric and performance requirements of the seal assembly when choosing the RFID transponder during design and manufacture. If the RFID transponder resides outside of these areas of interaction, it makes both seal design and manufacture easier and less costly.

Finally, it is advantageous to all parties from the manufacturer to the end user, to physically locate the RFID transponder in a permanent section of the seal outside of the body of the sealing member because this allows the incorporation of such uniquely identifiable information with the seal without changing the form, fit or function of the seal body itself. As those familiar with high requirement, highly regulated, validated processes will understand, this makes the incorporation of the RFID transponder much easier and less expensive as requalification and revalidation may not be as complicated or be required at all.

### Prior Art

As illustrated in FIG. 1, RFID tags 12 have in the past been wired to large seals buried underground. See US 20070057769A. While this may help to locate a large buried seal, both its tamper resistance and permanence are doubtful. Similarly, the application is limited to adequately large seals with access to affix an RFID tag or to seal assemblies.

As will be apparent to those skilled in the art, small and poorly accessible gaskets and O-rings are problematic for RFID applications. As shown in FIG. 2, RFID tags 11 have also in the past been buried inside of O-rings. See U.S. Pat. No. 8,282,013B2. However, for such tags to fit inside small O-rings, they must be significantly smaller than the cross-section of the O-ring. Because RFID tags contain antennae, it is typically necessary to be very proximate to the article or even make physical contact with the RFID tag for it to charge and function. This makes tracking O-rings and other enclosed sealing members impossible during use. In addition, RF interference from surrounding metallic structures electronically screen the RFID tag making them unreadable during use. The presence of the RFID tag inside the seal material may interfere with the sealing characteristics of the O-ring and reduce the longevity and durability of the same as sealing stresses are concentrated around the tag.

### SUMMARY OF THE INVENTION

The present RFID-tagged seal and method of manufacture basically comprise a molded fluid-sealing body formed from resilient material and adapted to mate with seal-receiving portions of fluid-processing equipment; an extension concurrently molded with the fluid-sealing body and designed to project beyond the seal-receiving portions, and an RFID transponder molded into the extension and positioned to function without interference from the fluid-processing equipment.

### BRIEF DESCRIPTION OF THE DRAWINGS

FIG. 1 is a perspective view of a section of a prior art gasket with an RFID device fastened thereto;

FIG. 2 is a sectional view of a second prior art gasket with an RFID device embedded therein;

FIG. 3 is a top view of an RFID-equipped sealing member according to the present invention;

FIG. 4 is a sectional view of the sealing member shown in FIG. 3;

FIG. 5 is an exploded view of the present sealing member and opposing housings in which the body of the sealing member may be seated; and

FIG. 6 is a perspective view of the sealing member and housings of FIG. 5 assembled and mounted in a clamp.

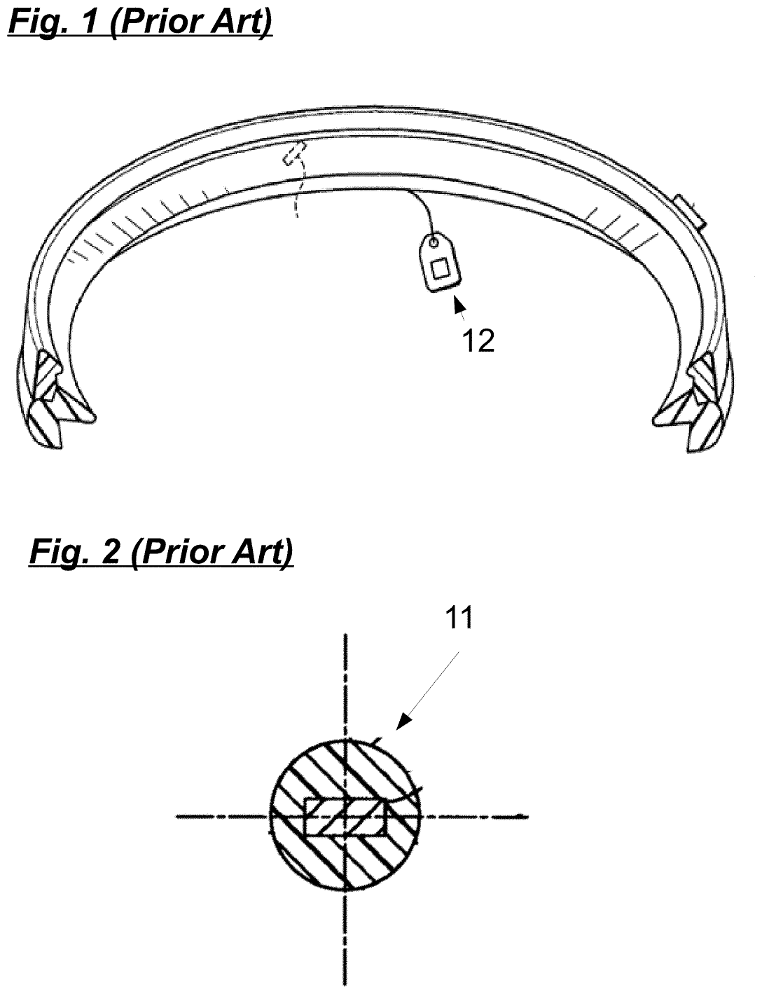

### DETAILED DESCRIPTION OF THE PREFERRED EMBODIMENT

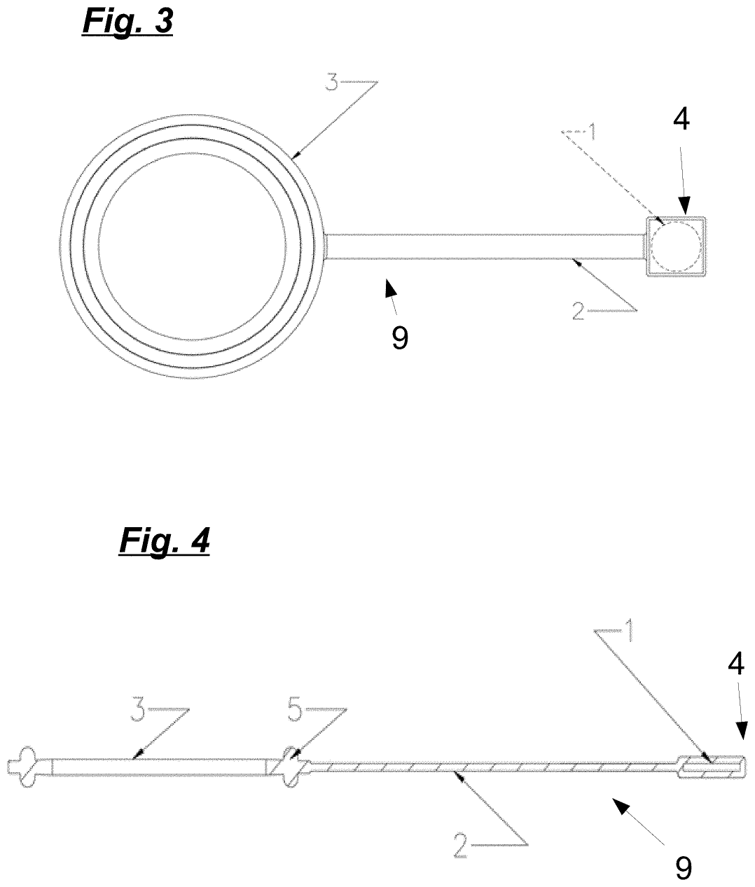

As illustrated in FIGS. 3-7, the present device, generally designated 9, basically comprises a fluid-sealing body 3, an extension or tongue 2 integrally formed with and projecting from the body, and at least one RFID transponder 1 molded into the extension 2. Preferably, the transponder is molded into a tag 4 defining a free end of the tongue 2. The fluid-sealing body or member 3 may be formed from a plastic, an elastomer or other resilient material and may be in the configuration of an O-ring, a sanitary gasket, or other shape so as to mate with seal-receiving hardware such as ferrules 6 or other mating surfaces. The tongue 2 is concurrently molded with the body 3 and may be of any shape or size required to both completely enclose the RFID transponder 1 uniquely, permanently and accessibly, and as the specific sealing member body 3, its application and its related sealing components 6, 7 may require.

The RFID transponder 1 may be programmed with a unique identifier specific to the particular sealing body 3 and may include data to be used at any time during manufacture, inspection, warehousing, sales, shipping or assembly into more complex equipment by an intermediate party or by the end user of the sealing member. Information contained in the transponder 1 may relate to the specific needs of the article, its application and or its owner/user. This may include part number, lot number serial number, material code, manufacturing date, specifications, installation date, sanitization date, and/or other maintenance information which then may be referenced and/or analyzed by appropriate means where such data is compiled electronically or by other means.

The transponder 1 makes it possible to know the identity and history of the sealing member even though it is in use and may have no other markings affixed or incorporated. In this manner, the benefits of tagging the seal during manufacturing and incorporating its unique identifier in a permanent manner is combined with avoiding the common problems of conventional means of marking a sealing member. No matter what the sealing member application may be, the seal performance is unaffected.

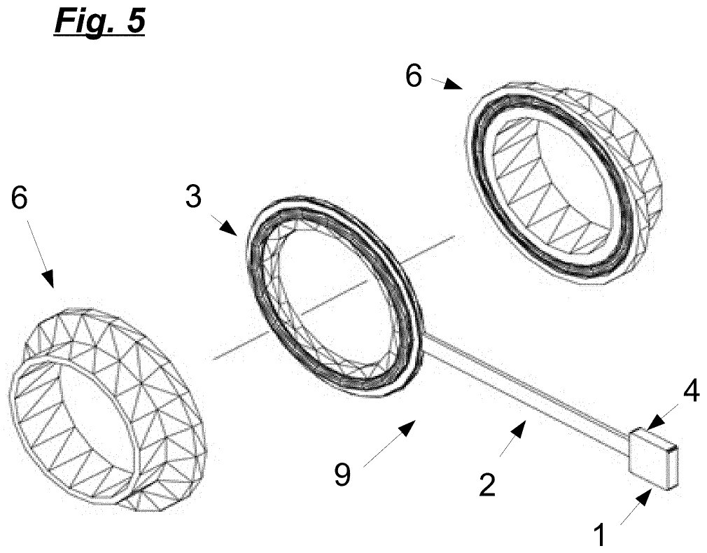

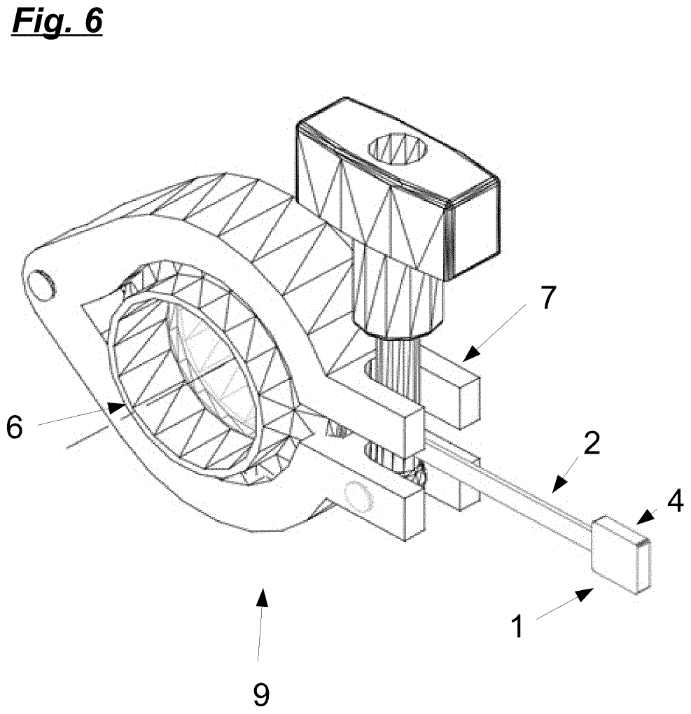

As shown in FIGS. 5 and 6, the tongue or extension 2 and the transponder tag 4 are shaped and sized to extend beyond the metallic seal housings or ferrules 6 and the mounting clamp 7 between which the fluid-sealing body 3 is interposed. In this manner, the extension 2 is designed so that the fluid-processing equipment does not interfere with transponder function. As may be seen, the metallic seal housings or ferrules 6 and the metallic clamp 7 would interfere with an RFID tag once assembled if the RFID tag were in or adjacent to the body of the sealing member 3 itself, for it would be completely surrounded by the piping, ferrules 6, and clamp 7. Also, with the foregoing extension 2, the mating surfaces of the seal body are left unchanged and are compressed normally.

The RFID transponder 1 may be embedded in a preform of unmolded, uncured, partially cured/cooled or otherwise incompletely processed resilient material. The unmolded preform may then be placed in a mold designed to create the final shape of the sealing body 3, the tongue or extension 2 and the transponder tab 4. Enough other material or preforms may be added as required to comprise the balance of the extension 2 and the body 3 of the sealing member. The assembly may then be molded, cured, cooled and finished using techniques known to those skilled in the art of molding sealing members from various materials.

1. An RFID-tagged seal adapted for use with fluid-processing equipment, said seal comprising:
(a) a molded fluid-sealing body formed from resilient material and adapted to mate with seal-receiving portions of the fluid-processing equipment;
(b) an extension concurrently molded with the fluid-sealing body, said extension projecting beyond said seal-receiving portions; and
(c) an RFID transponder molded into the extension and positioned to function without interference from the fluid-processing equipment.

2. A method of making an RFID-tagged seal adapted for use with fluid processing equipment, said method comprising:
(a) Embedding an RFID transponder in a preform of resilient material;
(b) Providing a mold for shaping
(i) a fluid-sealing body adapted to mate with seal-receiving portions of the fluid-processing equipment,
(ii) an extension projecting from the fluid-sealing body and
(iii) the RFID preform at a free end of said extension and positioned to function without interference from the fluid-processing equipment;
(c) Adding resilient material to the mold for integrally forming the fluid-sealing body, the extension and the RFID preform; and
(d) Curing, cooling and finishing the RFID-tagged seal.
